(19) United States
(12) Patent Application Publication
(10) Pub. No.: US 2021/0394583 A1
(43) Pub. Date: Dec. 23, 2021

(54) IN-VEHICLE-CABIN STORAGE DEVICE

(71) Applicant: TOYOTA JIDOSHA KABUSHIKI KAISHA, Aichi-ken (JP)

(72) Inventors: Hideyuki SAKURAI, Toyota-shi (JP); Mitsuyoshi OHNO, Miyoshi-shi (JP)

(21) Appl. No.: 17/316,619

(22) Filed: May 10, 2021

(30) Foreign Application Priority Data
Jun. 23, 2020 (JP) 2020-108274

(51) Int. Cl. B60H 1/00; B60N 3/08

(52) U.S. Cl. CPC B60H 1/00564; B60N 3/08

(57) ABSTRACT

An in-vehicle-cabin storage device includes an exhaust device having a duct, and the duct provides communication between the inside of a storage part and the outside of a vehicle cabin. When the atmospheric pressure inside the storage part is higher than the atmospheric pressure outside the vehicle cabin, the exhaust device secures ventilation from the inside of the storage part to the outside of the vehicle cabin.

### CROSS-REFERENCE TO RELATED APPLICATION

This application claims priority to Japanese Patent Application No. 2020-108274 filed on Jun. 23, 2020, incorporated herein by reference in its entirety.

### BACKGROUND

### 1. Technical Field

The present disclosure relates to an in-vehicle-cabin storage device.

### 2. Description of Related Art

Japanese Patent Application Publication No. 8-217201 discloses an disclosure related to an on-board trash box. A trash box main body of this on-board trash box is attachable to and detachable from a clip that is provided on a floor mat disposed inside a vehicle cabin. Thus, to empty the trash box main body in which trash has accumulated, one can quickly take out the trash box main body from inside the vehicle cabin.

### SUMMARY

Trash having accumulated inside the trash box main body gives off odors, which can leak from the inside of the trash box main body into the vehicle cabin.

Since the above related art is not provided with measures against odors given off by trash, the odors of trash can drift into the vehicle cabin. Measures against odors are needed also when a container holding food or drink is disposed inside a vehicle cabin, as odors given off by the food or drink can leak from the inside of the container into the vehicle cabin. Thus, the above related art has room for improvement in terms of securing a space to store things inside a vehicle cabin while also reducing the likelihood that odors given off by the things may drift into the vehicle cabin.

In view of this fact, the present disclosure aims to provide an in-vehicle-cabin storage device that can secure a space to store things inside a vehicle cabin while also reducing the likelihood that odors given off by the things may drift into the vehicle cabin.

An in-vehicle-cabin storage device according to the present disclosure described in claim 1 includes: a storage part that is disposed inside a vehicle cabin of a vehicle and capable of storing things; and an exhaust part that includes a duct capable of providing communication between the inside of the storage part and the outside of the vehicle cabin, and that secures ventilation from the inside of the storage part to the outside of the vehicle cabin when the atmospheric pressure inside the storage part is higher than the atmospheric pressure outside the vehicle cabin.

According to the present disclosure described in claim 1, the storage part is disposed inside the vehicle cabin of the vehicle, and occupants can store various things inside the storage part.

When things that occupants store inside the storage part are trash or food and drink, odors given off by these things can drift into the vehicle cabin.

Here, the present disclosure includes the exhaust part having the duct, and the duct can provide communication between the inside of the storage part and the outside of the vehicle cabin. When the atmospheric pressure inside the storage part is higher than the atmospheric pressure outside the vehicle cabin, the exhaust part secures ventilation from the inside of the storage part to the outside of the vehicle cabin.

Thus, when the atmospheric pressure inside the storage part is higher than the atmospheric pressure outside the vehicle cabin, odors inside the storage part can be expelled to the outside of the vehicle cabin.

An in-vehicle-cabin storage device according to the present disclosure described in claim 2 is the in-vehicle-cabin storage device described in claim 1, wherein the inside of the storage part is dividable into one side and the other side.

According to the present disclosure described in claim 2, the inside of the storage part can be divided into the one side and the other side, and the one side and the other side of the inside of the storage part can be used each for a different purpose.

An in-vehicle-cabin storage device according to the present disclosure described in claim 3 is the in-vehicle-cabin storage device described in claim 2, wherein a support part which is attachable to and detachable from the storage part and capable of dividing the inside of the storage part into an upper side and a lower side in a height direction of the storage part, and on which things are placeable is disposed inside the storage part; and the support part has a through-hole that provides communication between one side and the other side of the inside of the storage part divided by the support part.

According to the present disclosure described in claim 3, the support part on which things are placeable is disposed inside the storage part, and the support part is attachable to and detachable from the storage part. Further, the support part can divide the inside of the storage part into the upper side and the lower side in the height direction of the storage part. Thus, inside the storage part, different things can be stored on the upper side and the lower side of the support part. For example, inside the storage part, food and drink can be placed on the support part while trash can be stored on the lower side of the support part.

In the present disclosure, the support part has the through-hole, and the through-hole provides communication between the one side and the other side of the inside of the storage part that is divided by the support part. Thus, inside the storage part, ventilation between the upper side and the lower side of the support part can be secured. As a result, odors given off by things on the upper side of the support part and odors given off by things on the lower side of the support part can be both expelled to the outside of the vehicle cabin through the exhaust part.

An in-vehicle-cabin storage device according to the present disclosure described in claim 4 is the in-vehicle-cabin storage device described in any one of claims 1 to 3, wherein the exhaust part further includes an air sending part capable of sending air inside the duct, from the side of the storage part to the outside of the vehicle cabin, and a control part that controls the air sending part; and the control part is capable of driving the air sending part when the speed of the vehicle is not higher than a predetermined speed.

According to the present disclosure described in claim 4, the air sending part is provided, and this air sending part can send air inside the duct, from the side of the storage part to the outside of the vehicle cabin.

When the vehicle is traveling at a speed higher than the predetermined speed, the outside of the vehicle cabin is under negative pressure relative to the inside of the storage part without the air sending part being driven, so that odors inside the storage part can be expelled to the outside of the vehicle cabin. Thus, when the vehicle is traveling at a speed higher than the predetermined speed, driving the air sending part is redundant from the viewpoint of expelling odors inside the storage part.

On the other hand, when the vehicle is traveling at a speed not higher than the predetermined speed or when the vehicle is stationary, it is difficult to create negative pressure outside the vehicle cabin relative to the inside of the storage part without driving the air sending part, and consequently it is difficult to expel odors inside the storage part to the outside of the vehicle cabin.

Here, the present disclosure includes the control part that controls the air sending part, and the control part drives the air sending part when the speed of the vehicle is not higher than the predetermined speed. Thus, also when the vehicle is traveling at a speed not higher than the predetermined speed or when the vehicle is stationary, odors inside the storage part can be expelled to the outside of the vehicle cabin.

An in-vehicle-cabin storage device according to the present disclosure described in claim 5 is the in-vehicle-cabin storage device described in any one of claims 1 to 4, wherein a part of the duct that is adjacent to an opening of the duct on an outer side of the vehicle cabin extends from the opening toward a vehicle upper side.

According to the present disclosure described in claim 5, the part of the duct that is adjacent to the opening of the duct on the outer side of the vehicle cabin extends from the opening toward the vehicle upper side. Therefore, water etc. having entered the duct through the opening of the duct on the outer side of the vehicle cabin returns to the opening side.

As described above, the in-vehicle-cabin storage device according to the present disclosure described in claim 1 has the excellent advantage of being able to secure a space to store things inside a vehicle cabin while also reducing the likelihood that odors given off by the things may drift into the vehicle cabin.

The in-vehicle-cabin storage device according to the present disclosure described in claim 2 has the excellent advantage of being able to secure the convenience of the space to store things.

The in-vehicle-cabin storage device according to the present disclosure described in claim 3 has the excellent advantage of being able to divide the space to store things while also expelling odors from each of the divided spaces.

The in-vehicle-cabin storage device according to the present disclosure described in claim 4 has the excellent advantage of being able to reduce the likelihood that odors given off by things may drift into the vehicle cabin, regardless of the traveling speed of the vehicle.

The in-vehicle-cabin storage device according to the present disclosure described in claim 5 has the excellent advantage of being able to reduce the likelihood that odors coming from water etc. having entered from the outside of the vehicle cabin may drift into the vehicle cabin.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective view schematically showing a relationship between an in-vehicle-cabin storage device according to an embodiment and a vehicle cabin;

FIG. 2 is a sectional view, as seen from a vehicle up-down direction, schematically showing the relationship between the in-vehicle-cabin storage device according to the embodiment and the vehicle cabin (a sectional view showing a state as cut along line 2-2 of FIG. 1);

FIG. 3 is a sectional view, as seen from a vehicle front-rear direction, schematically showing the in-vehicle-cabin storage device according to the embodiment (a sectional view showing a state as cut along line 3-3 of FIG. 1);

FIG. 4 is a sectional view, as seen from a vehicle width direction, schematically showing a configuration at an interface between the in-vehicle-cabin storage device according to the embodiment and a door inner panel (a sectional view showing a state as cut along line 4-4 of FIG. 2); and

FIG. 5 is a side view, as seen from the vehicle width direction, schematically showing a relationship between the in-vehicle-cabin storage device according to the embodiment and a side door (a view in the direction of arrow 5 of FIG. 2).

### DETAILED DESCRIPTION OF EMBODIMENTS

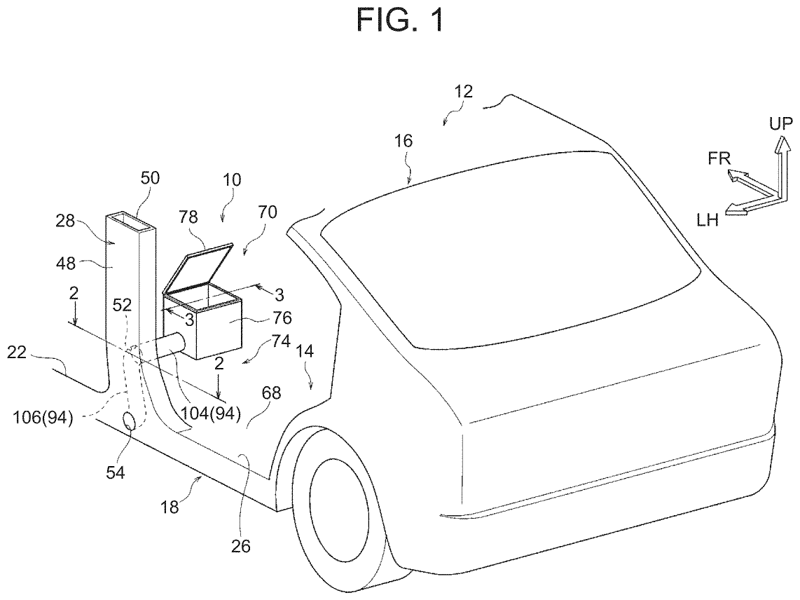

One example of embodiments of an in-vehicle-cabin storage device according to the present disclosure will be described below using FIG. 1 to FIG. 5. Arrows FR, UP, and LH shown as necessary in the drawings indicate a vehicle front side, a vehicle upper side, and a left side in a vehicle width direction, respectively, of a “vehicle 12” that is provided with an “in-vehicle-cabin storage device 10” according to the embodiment.

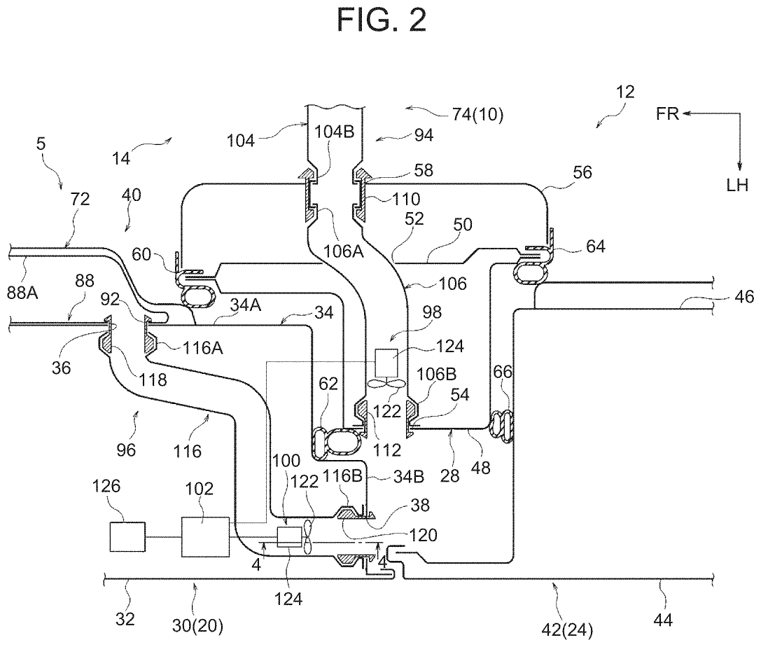

As shown in FIG. 1 and FIG. 2, the vehicle 12 includes a vehicle body 16 that constitutes a main part of a “vehicle cabin 14.” A side part 18 of the vehicle body 16 includes a front-side opening 22 that is opened and closed by a front side door 20, a rear-side opening 26 that is opened and closed by a rear side door 24, and a center pillar 28 that is interposed between the front-side opening 22 and the rear-side opening 26.

The following description will be given based on the assumption that the front-side opening 22 and the rear-side opening 26 are closed by the front side door 20 and the rear side door 24, respectively.

The front side door 20 includes a door main body 30 that constitutes a main part of the front side door 20. The door main body 30 includes a door outer panel 32 that constitutes a part of the door main body 30 on an outer side in the vehicle width direction, and a door inner panel 34 that constitutes a part of the door main body 30 on an inner side in the vehicle width direction.

The door inner panel 34 includes a side wall 34A which constitutes a part of the door inner panel 34 on the inner side in the vehicle width direction and of which a plate thickness direction lies in the vehicle width direction, and a rear wall 34B which constitutes a part of the door inner panel 34 on a vehicle rear side and of which a plate thickness direction lies in the vehicle front-rear direction.

The side wall 34A has a through-hole 36 formed at a part on the vehicle rear side as well as a vehicle lower side, and the rear wall 34B has a through-hole 38 formed at a part on the vehicle lower side. The through-hole 38 is located on the vehicle lower side relative to the through-hole 36.

A door trim 40 that covers the door inner panel 34 from the inner side in the vehicle width direction is mounted on the door inner panel 34.

The rear side door 24 includes a door main body 42 that constitutes a main part of the rear side door 24. The door main body 42 includes a door outer panel 44 that constitutes a part of the door main body 42 on the outer side in the vehicle width direction, and a door inner panel 46 that constitutes a part of the door main body 42 on the inner side in the vehicle width direction.

The center pillar 28 extends in the vehicle up-down direction, and includes a pillar outer panel 48 that constitutes a part of the center pillar 28 on the outer side in the vehicle width direction and a pillar inner panel 50 that constitutes a part of the center pillar 28 on the inner side in the vehicle width direction. The pillar inner panel 50 has a through-hole 52 formed at a part on the vehicle lower side, and the pillar outer panel 48 has a through-hole 54 formed at a part on the vehicle lower side. The through-hole 54 is located on the vehicle lower side relative to the through-hole 52.

A pillar garnish 56 that covers the pillar inner panel 50 from the inner side in the vehicle width direction is mounted on the pillar inner panel 50. The pillar garnish 56 has a through-hole 58 formed at a part on the vehicle lower side, and the through-hole 58 partially overlaps the through-hole 52 of the pillar inner panel 50 as seen from the vehicle width direction.

A weather strip 60 is mounted at a peripheral edge of the center pillar 28 on the vehicle front side, along the peripheral edge, and the weather strip 60 is in close contact with the front side door 20.

A weather strip 62 is mounted at a peripheral edge of the front side door 20 so as to form an annular shape as seen from the vehicle width direction, and the weather strip 62 is in close contact with the center pillar 28 etc.

A weather strip 64 is mounted at a peripheral edge of the center pillar 28 on the vehicle rear side, along the peripheral edge, and the weather strip 64 is in close contact with the rear side door 24.

A weather strip 66 is mounted at a peripheral edge of the rear side door 24 so as to form an annular shape as seen from the vehicle width direction, and the weather strip 66 is in close contact with the center pillar 28 etc.

Here, a first feature of this embodiment is that a “storage part 70” constituting a part of the in-vehicle-cabin storage device 10 is provided on the vehicle upper side of a floor panel 68 of the vehicle body 16. A second feature is that a “storage part 72” constituting a part of the in-vehicle-cabin storage device 10 is provided in the door trim 40. A third feature is that ventilation from the inside of the storage part 70 and the inside of the storage part 72 to the outside of the vehicle cabin 14 is enabled by an “exhaust device 74” as an exhaust part constituting a part of the in-vehicle-cabin storage device 10.

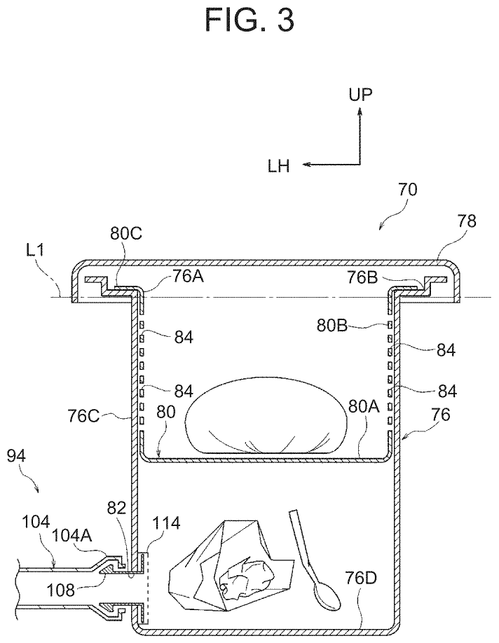

As shown in FIG. 3, the storage part 70 includes an outer case 76 and a lid 78, and an “inner case 80” as a support part is disposed inside the storage part 70. Specifically, the outer case 76 as a whole has a shape of a cuboid that is open on the vehicle upper side. At a peripheral edge of an opening 76A of the outer case 76 on the vehicle upper side, an edge plate portion 76B is provided which protrudes from the inner side toward the outer side of the outer case 76 and of which a plate thickness direction lies in the vehicle up-down direction. A peripheral wall 76C of the outer case 76 has a through-hole 82 formed at a part on the outer side in the vehicle width direction (on the left side in the vehicle width direction).

The lid 78 has a shape of a plate that can cover the outer case 76 from the vehicle upper side. The lid 78 is coupled to the outer case 76 through a shaft (not shown) and can turn around an axis L1 relatively to the outer case 76.

The inner case 80 as a whole has a shape of a cuboid of which the external volume is set to about half of the external volume of the outer case 76 and which is open on the vehicle upper side, and the inner case 80 is located on the vehicle upper side inside the outer case 76. Thus, there is a space left between a bottom wall 76D of the outer case 76 and a bottom wall 80A of the inner case 80.

Further, a clearance is left between a peripheral wall 80B of the inner case 80 and the peripheral wall 76C of the outer case 76, and the peripheral wall 80B has a plurality of through-holes 84 formed therein that forms a fine-mesh pattern.

At a peripheral edge of the inner case 80 on the vehicle upper side, an edge plate portion 80C is provided which protrudes from the inner side toward the outer side of the inner case 80 and of which a plate thickness direction lies in the vehicle up-down direction. The edge plate portion 80C of the inner case 80 is brought into contact with the edge plate portion 76B of the outer case 76 from the vehicle upper side and, in this state, detachably engaged with an engaging part (not shown) provided in the edge plate portion 76B.

The inside of the storage part 70 thus configured is divided by the inner case 80 into an upper side and a lower side in a height direction of the storage part 70, and things can be placed on each of the vehicle upper side of the bottom wall 76D of the outer case 76 and the vehicle upper side of the bottom wall 80A of the inner case 80. Further, communication between one side and the other side of the inside of the storage part 70 divided by the inner case 80 is provided by the through-holes 84 of the inner case 80.

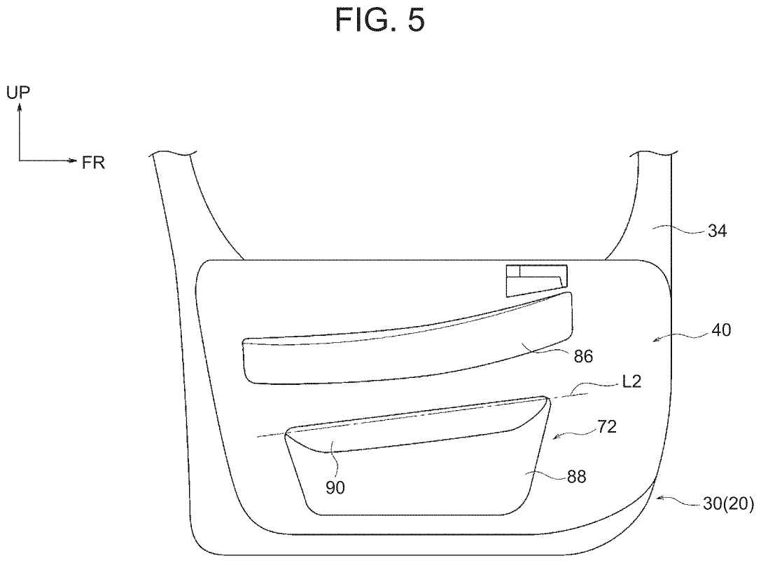

As shown in FIG. 2 and FIG. 5, the storage part 72 has a case main body 88 that is provided integrally with the door trim 40 of the front side door 20 and disposed on the vehicle lower side of an armrest 86, and a lid 90. The case main body 88 has a rectangular shape with the width increasing from the vehicle lower side toward the vehicle upper side as seen from the vehicle width direction, as well as has a box shape with an opening 88A provided on the vehicle upper side.

The case main body 88 has a through-hole 92 formed at a part on the outer side in the vehicle width direction, and most of the through-hole 92 overlaps the through-hole 36 of the door inner panel 34 as seen from the vehicle width direction.

The lid 90 has a shape of a plate that can cover the opening 88A of the case main body 88 from the vehicle upper side. The lid 90 is coupled to the case main body 88 through a shaft (not shown) and can turn around an axis L2 relatively to the case main body 88.

The storage part 72 thus configured allows things to be stored inside the case main body 88.

Next, the configuration of the exhaust device 74 will be described using FIG. 1 to FIG. 4. The exhaust device 74 includes a “duct 94,” a “duct 96,” a “fan 98” and a “fan 100” as air sending parts, and a “control device 102” as a control part.

The duct 94 includes a pipe member 104, a pipe member 106, a connector 108, a connector 110, and a “connector 112.” Specifically, the pipe member 104 has a shape of a tube extending in the vehicle width direction, and an end 104A of the pipe member 104 on one side is coupled to the outer case 76 through the connector 108 that is fitted in the through-hole 82 of the outer case 76. Thus, the connector 108 functions as an opening of the duct 94 on the side of the storage part 70. A filter 114 is mounted on the connector 108 from the inside of the outer case 76.

An end 104B of the pipe member 104 on the other side is coupled to the pillar garnish 56 through the connector 110 that is fitted in the through-hole 58 of the pillar garnish 56.

An end 106A of the pipe member 106 on one side is coupled to the pillar garnish 56 through the connector 110, and from the end 106A to an end 106B on the other side, the pipe member 106 extends toward the vehicle lower side via the through-hole 52 of the pillar inner panel 50.

The end 106B of the pipe member 106 on the other side is coupled to the pillar outer panel 48 through the connector 112 that is fitted in the through-hole 54 of the pillar outer panel 48. Thus, the connector 112 functions as an opening of the duct 94 on the outer side of the vehicle cabin 14. A part of the duct 94 thus configured that is adjacent to the connector 112 can be regarded as extending from the connector 112 toward the vehicle upper side.

The duct 96 includes a pipe member 116, a connector 118, and a “connector 120.” Specifically, an end 116A of the pipe member 116 on one side is coupled to the connector 118 that is fitted in the through-hole 36 of the door inner panel 34 and the through-hole 92 of the case main body 88. Thus, the connector 118 functions as an opening of the duct 96 on the side of the storage part 72. A filter (not shown) is mounted on the connector 118 from the inner side of the case main body 88.

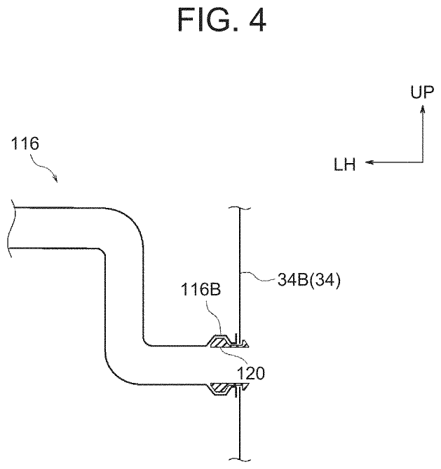

From the end 116A to an end 116B on the other side, the pipe member 116 extends inside the door main body 30 toward the vehicle lower side. The end 116B of the pipe member 116 on the other side is coupled to the door inner panel 34 through the connector 120 that is fitted in the through-hole 38 of the door inner panel 34. Thus, the connector 120 functions as an opening of the duct 96 on the outer side of the vehicle cabin 14. As shown in FIG. 4, a part of the pipe member 116 that is adjacent to the connector 120 extends from the connector 120 toward the vehicle upper side.

Referring to FIG. 2 again, the fan 98 is disposed inside the duct 94 and includes an impeller 122 and a motor 124. Electricity can be supplied to the motor 124 from an electricity supply part (not shown) installed in the vehicle 12, such as a battery. The motor 124 is electrically connected to the control device 102 and can be driven based on a control signal from the control device 102. As the motor 124 is driven, the fan 98 turns the impeller 122 and thereby sends air from the side of the storage part 70 to the outside of the vehicle cabin 14.

More specifically, the control device 102 is installed in the vehicle 12 and includes a central processing unit (CPU), a read-only memory (ROM), a random-access memory (RAM), a storage, a communication interface, and an input-output interface (none of which is shown).

The control device 102 is electrically connected to a speed sensor 126 installed in the vehicle 12, and when a signal based on the speed of the vehicle 12 is input from the speed sensor 126 into the control device 102, the control device 102 outputs a control signal to the motor 124 based on this signal. In particular, when the speed of the vehicle 12 is not higher than a predetermined speed (e.g., 20 [km/h]), the control device 102 drives the fan 98, and when the speed of the vehicle 12 is higher than the predetermined speed, the control device 102 does not drive the fan 98.

The fan 100 is disposed inside the duct 96, and has the same configuration as the fan 98 and includes an impeller 122 and a motor 124. The fan 100 is controlled by the control device 102 in the same manner as the fan 98, and is driven to send air from the side of the storage part 72 to the outside of the vehicle cabin 14.

Workings and Effects of Embodiment

Next, the workings and effects of this embodiment will be described.

As shown in FIG. 1 and FIG. 2, in this embodiment, the storage part 70 and the storage part 72 are disposed inside the vehicle cabin 14 of the vehicle 12, and occupants can store various things inside the storage part 70 and the storage part 72.

When things that occupants store in the storage part 70 and the storage part 72 are trash or food and drink, odors given off by these things can drift into the vehicle cabin 14.

Here, this embodiment includes the exhaust device 74 having the duct 94 and the duct 96. The duct 94 provides communication between the inside of the storage part 70 and the outside of the vehicle cabin 14, while the duct 96 provides communication between the inside of the storage part 72 and the outside of the vehicle cabin 14. When the atmospheric pressures inside the storage part 70 and the storage part 72 are higher than the atmospheric pressure outside the vehicle cabin 14, the exhaust device 74 secures ventilation from the inside of the storage part 70 and the inside of the storage part 72 to the outside of the vehicle cabin 14.

Thus, when the atmospheric pressures inside the storage part 70 and the storage part 72 are higher than the atmospheric pressure outside the vehicle cabin 14, odors inside the storage part 70 and the storage part 72 can be expelled to the outside of the vehicle cabin 14. In this embodiment, therefore, it is possible to secure a space to store things inside the vehicle cabin 14 while also reducing the likelihood that odors given off by the things may drift into the vehicle cabin 14.

As shown in FIG. 3, in this embodiment, the inner case 80 in which things are placeable is disposed inside the storage part 70, and the inner case 80 is attachable to and detachable from the storage part 70. The inner case 80 can divide the inside of the storage part 70 into the upper side and the lower side in the height direction of the storage part 70. Thus, inside the storage part 70, different things can be stored on the upper side and the lower side of the inner case 80. For example, inside the storage part 70, food and drink can be placed in the inner case 80 while trash can be stored on the lower side of the inner case 80.

In this embodiment, the inner case 80 has the through-holes 84, and the through-holes 84 provide communication between the one side and the other side of the inside of the storage part 70 that is divided by the inner case 80. Thus, inside the storage part 70, ventilation between the upper side and the lower side of the inner case 80 can be secured. As a result, odors given off by things on the upper side of the inner case 80 and odors given off by things on the lower side of the inner case 80 can be both expelled to the outside of the vehicle cabin 14 through the exhaust device 74. In this embodiment, therefore, it is possible to divide the space to store things while also expelling odors from each of the divided spaces.

Referring to FIG. 2 again, this embodiment includes the fan 98 and the fan 100. The fan 98 can send air inside the duct 94, from the side of the storage part 70 to the outside of the vehicle cabin 14. The fan 100 can send air inside the duct 96, from the side of the storage part 72 to the outside of the vehicle cabin 14.

When the vehicle 12 is traveling at a speed higher than the predetermined speed, the outside of the vehicle cabin 14 is under negative pressure relative to the inside of the storage part 70 and the inside of the storage part 72 without the fan 98 and the fan 100 being driven, so that odors inside the storage part 70 and the storage part 72 can be expelled to the outside of the vehicle cabin 14 without consuming electricity. Thus, when the vehicle 12 is traveling at a speed higher than the predetermined speed, driving the fan 98 and the fan 100 is redundant from the viewpoint of expelling odors inside the storage part 70 and the storage part 72.

On the other hand, when the vehicle 12 is traveling at a speed not higher than the predetermined speed or when the vehicle 12 is stationary, it is difficult to create negative pressure outside the vehicle cabin 14 relative to the inside of the storage part 70 and the inside of the storage part 72 without driving the fan 98 and the fan 100. Consequently, it is difficult to expel odors inside the storage part 70 and the storage part 72 to the outside of the vehicle cabin 14.

Here, this embodiment includes the control device 102 that controls the fan 98 and the fan 100, and the control device 102 drives the fan 98 and the fan 100 when the speed of the vehicle 12 is not higher than the predetermined speed. Thus, also when the vehicle 12 is traveling at a speed not higher than the predetermined speed or when the vehicle 12 is stationary, odors inside the storage part 70 and the storage part 72 can be expelled to the outside of the vehicle cabin 14. In this embodiment, therefore, the likelihood that odors given off by things may drift into the vehicle cabin 14 can be reduced regardless of the traveling speed of the vehicle 12.

In addition, in this embodiment, the part of each of the duct 94 and the duct 96 that is adjacent to the opening thereof on the outer side of the vehicle cabin 14 extends from the opening toward the vehicle upper side. Thus, water etc. having entered the duct 94 or the duct 96 through the opening thereof on the outer side of the vehicle cabin 14 returns to the opening side. In this embodiment, therefore, the likelihood that odors coming from water etc. having entered from the outside of the vehicle cabin 14 may drift into the vehicle cabin 14 can be reduced.

Supplementary Description of Embodiment

(1) In the above embodiment, the in-vehicle-cabin storage device 10 according to the embodiment is disposed at a part of the vehicle 12 on the left side in the vehicle width direction. However, the present disclosure is not limited to this example. Depending on the specifications of the vehicle 12 etc., the in-vehicle-cabin storage device 10 may be disposed at a part of the vehicle 12 on the right side in the vehicle width direction.

(2) In the above embodiment, the connector 112 mounted on the pillar outer panel 48 and the connector 120 mounted on the door inner panel 34 are open at all times on the outer side of the vehicle cabin 14. However, the present disclosure is not limited to this example. For example, depending on the specifications of the vehicle 12 etc., each of the connector 112 and the connector 120 may be provided with a valve that is activated and closes the ventilation passage when the atmospheric pressure inside the vehicle cabin 14 becomes lower than the atmospheric pressure outside the vehicle cabin 14. Further, when the specifications of the in-vehicle-cabin storage device 10 is such that expelling odors inside the storage part 70 and the storage part 72 is not needed when the vehicle 12 is stationary, this valve may be used as the exhaust part in place of the exhaust device 74.

(3) In the above embodiment, the control device 102 drives the fan 98 and the fan 100 based on a signal from the speed sensor 126. However, the present disclosure is not limited to this example. For example, depending on the specifications of the vehicle 12 etc., an atmospheric pressure sensor and an odor sensor that are electrically connected to the control device 102 may be disposed in the vehicle 12, and when the odor sensor detects an odor not lower than a predetermined value and, moreover, the atmospheric pressure inside the vehicle cabin 14 is lower than the atmospheric pressure outside the vehicle cabin 14, the control device 102 may drive the fan 98 and the fan 100. Depending on the specifications of the vehicle 12 etc., it is also possible to adopt a blower instead of the fan 98 and the fan 100.

(4) Further, in the above embodiment, the in-vehicle-cabin storage device 10 includes the storage part 70 and the storage part 72. However, the present disclosure is not limited to this example. Depending on the specifications of the vehicle 12 etc., the in-vehicle-cabin storage device 10 may include either the storage part 70 or the storage part 72. The storage part 72 may be provided in the rear side door 24.

(5) Furthermore, in the above embodiment, the inside of the storage part 70 can be divided by the inner case 80 into the upper side and the lower side in the height direction of the storage part 70. However, the present disclosure is not limited to this example. For example, a partitioning part that divides the inside of the outer case 76 into the one side and the other side in the vehicle width direction may be provided inside the outer case 76, and a pair of lids that can be moved so as to slide in the vehicle width direction may be provided on the vehicle upper side of the outer case 76. This configuration allows the one side and the other side of the inside of the storage part 70 to be used each for a different purpose; for example, inside the outer case 76, the space on one side in the vehicle width direction may communicate with the outside of the vehicle cabin 14 and be used to store trash, while the space on the other side in the vehicle width direction may be used as a cold storage chamber. As a result, the convenience of the space to store things can be secured. Similarly, the inside of the storage part 70 may be divided into one side and the other side in the vehicle front-rear direction.

What is claimed is:

1. An in-vehicle-cabin storage device comprising:
a storage part that is disposed inside a vehicle cabin of a vehicle and capable of storing things; and
an exhaust part that includes a duct capable of providing communication between an inside of the storage part and an outside of the vehicle cabin, and that secures ventilation from the inside of the storage part to the outside of the vehicle cabin when an atmospheric pressure inside the storage part is higher than an atmospheric pressure outside the vehicle cabin.

2. The in-vehicle-cabin storage device according to claim 1, wherein the inside of the storage part is dividable into one side and the other side.

3. The in-vehicle-cabin storage device according to claim 2, wherein:
a support part which is attachable to and detachable from the storage part and capable of dividing the inside of the storage part into an upper side and a lower side in a height direction of the storage part, and on which things are placeable is disposed inside the storage part; and
the support part has a through-hole that provides communication between one side and the other side of the inside of the storage part divided by the support part.

4. The in-vehicle-cabin storage device according to claim 1, wherein:
the exhaust part further includes an air sending part capable of sending air inside the duct, from a side of the storage part to the outside of the vehicle cabin, and a control part that controls the air sending part; and
the control part is capable of driving the air sending part when a speed of the vehicle is not higher than a predetermined speed.

5. The in-vehicle-cabin storage device according to claim 1, wherein a part of the duct that is adjacent to an opening of the duct on an outer side of the vehicle cabin extends from the opening toward a vehicle upper side.
